(19) United States
(12) Patent Application Publication
(10) Pub. No.: US 2025/0059034 A1
(43) Pub. Date: Feb. 20, 2025

(54) MIXED METAL OXIDE NANOWIRE CATALYSTS FOR METHANE REFORMING AND METHODS OF PRODUCTION THEREOF

(71) Applicant: Advanced Energy Materials, LLC, Louisville, KY (US)

(72) Inventors: Mahendra Kumar Sunkara, Louisville, KY (US); Veerendra Atla, Framingham, MA (US); Sivakumar Vasireddy, San Antonio, TX (US); Abhinav Nouduri, Louisville, KY (US)

(21) Appl. No.: 18/805,703

(22) Filed: Aug. 15, 2024

Related U.S. Application Data
(60) Provisional application No. 63/532,990, filed on Aug. 16, 2023.

(51) Int. Cl. C01B 3/40; B01J 21/06; B01J 23/72; B01J 23/755; B01J 23/80; B01J 35/45; B01J 35/56; B01J 35/58; B01J 37/04; B01J 37/08

(52) U.S. Cl. CPC C01B 3/40; B01J 21/066; B01J 23/72; B01J 23/755; B01J 23/80; B01J 35/45; B01J 35/56; B01J 35/58; B01J 37/04; B01J 37/086; C01B 2203/0233; C01B 2203/0238; C01B 2203/0244; C01B 2203/1011; C01B 2203/1023; C01B 2203/1052; C01B 2203/1058; C01B 2203/1076; C01B 2203/1241

(57) ABSTRACT

A nanowire catalyst is provided. The catalyst has the formula AₓC₁₋ₓO_{d}, wherein A is a transition metal or precious metal and wherein C is selected from the group consisting of silicon, aluminum, titanium, zinc, and manganese. Methods for preparing the nanowire catalyst include steps of mixing a binary oxide nanowire powder having element C with a precursor of element A to form a mixture; drying the mixture; and calcining the mixture to provide the nanowire catalyst. The catalyst may be used in methods of dry methane reforming, including bi-reforming and tri-reforming of methane.

### CROSS-REFERENCE TO RELATED APPLICATIONS

This application claims the benefit of U.S. Provisional Patent Application 63/532,990 filed on Aug. 16, 2023, the complete contents of which are herein incorporated by reference.

### FIELD OF THE INVENTION

The present disclosure is directed to mixed metal oxide nanowire catalysts. In particular, the catalysts are useful for methods of dry methane reforming, including bi-reforming and tri-reforming of methane.

### BACKGROUND OF THE INVENTION

Reforming of hydrocarbons is used for producing hydrogen for many chemical industries. In particular, methane and Naphtha are reformed using steam to produce hydrogen used in chemical and refining industries across the world. These processes produce large amounts of CO₂. There has been a significant interest in dry reforming reactions involving CO₂ instead of steam.

DMR (Dry methane reforming) reaction is an environmentally important process as it uses the greenhouse gases such as methane and carbon dioxide¹. Also, it produces a mixture of CO and hydrogen known as syngas, a fuel gas used in the production of high value chemicals. The product formation reaction is an endothermic reaction. However, rapid coke formation and sintering of catalyst particles at high reaction temperature are the bottlenecks to the commercialization of DMR reaction. Also, Ni catalyst particle size (such as >7 nm) is known to significantly influence the coke formation during DMR reaction².

Tri-methane reforming is a combination of three main reactions which take place in a single reactor: steam methane reforming (SMR), dry methane reforming (DMR), and partial oxidation of methane (POM) (FIG. 1). The first two reactions have an endothermic character, while the POM reaction is exothermic, which allows to obtain the energy necessary for the other two processes in situ.

Although tri-reforming has not yet been implemented commercially like steam or to dry reforming, Ni catalysts supported on a wide range of different support materials such as Al₂O₃, ZrO₂, MgO, TiO₂, CeO₂, TiO₂, CeZrO and SiO₂ are the most popular catalysts for tri-reforming of methane. However, it was suggested that in the tri-reforming reaction, re-oxidation of catalyst by oxygen present in the feed can lead to the deactivation of the catalysts.

Thus, there exists a need for new catalysts useful for methods of dry methane reforming.

### SUMMARY

The present disclosure provides atomically dispersed or alloyed catalysts in nanowire form that are useful for reforming reactions and show high activity and no or less coking. The nanowire catalysts also exhibit less or no sintering at higher reaction temperatures.

One aspect of the disclosure provides a nanowire catalyst having the formula AₓC₁₋ₓO_{d}, wherein A is a transition metal or precious metal and wherein C is selected from the group consisting of silicon, aluminum, titanium, zinc, and manganese. In some embodiments, A is selected from the group consisting of nickel, iron, cobalt, tungsten, platinum, ruthenium, and iridium. In some embodiments, the catalyst is NiₓTi₁₋ₓO_{2-d}, Ni_{y}Al_{2-y}O_{3-d}, or NiₓMn₁₋ₓO_{2-δ}. In some embodiments, the nanowire has a length of 0.5-20 microns and a diameter of 5-200 nm. In some embodiments, the catalyst has the formula AₓB_{y}C_{1-x-y}O_{d}, wherein B is a precious metal.

Another aspect of the disclosure provides a composition comprising a nanowire catalyst as described herein, wherein A is present in an amount of 1-20 wt %. In some embodiments, the nanowire catalyst is coated on or impregnated within a monolith. In some embodiments, the nanowire catalyst is formed into an extrudate.

Another aspect of the disclosure provides a method for preparing a nanowire catalyst as described herein, comprising mixing a binary oxide nanowire powder having element C with a precursor of element A to form a mixture; drying the mixture; and calcining the mixture to provide the nanowire catalyst. In some embodiments, the precursor is an acetate, formate, oxalate, or nitrate precursor. In some embodiments, the calcining step is performed at 250-500° C. for 0.5-3 hours.

Another aspect of the disclosure provides a method for dry methane reforming, comprising reacting CO₂ and CH₄ in the presence of a nanowire catalyst as described herein to produce CO and H₂. In some embodiments, a ratio of CO₂ to CH₄ is from 2:1 to 1:2. In some embodiments, the method is performed at a temperature of 700-900° C. In some embodiments, the method is performed under plasma conditions, e.g. using microwave, radio-frequency, or dielectric barrier discharges.

Another aspect of the disclosure provides a method for bi-reforming of methane, comprising reacting CO₂, CH₄, and H₂O in the presence of a nanowire catalyst as described herein to produce CO and H₂.

Another aspect of the disclosure provides a method for tri-reforming of methane, comprising reacting CO₂, CH₄, H₂O, and O₂ in the presence of a nanowire catalyst as described herein to produce CO and H₂.

### BRIEF DESCRIPTION OF THE DRAWINGS

The present invention is illustrated by way of example, and not by way of limitation, in the figures of the accompanying drawings and in which like reference numerals refer to similar elements. Unless otherwise indicated illustrations in the figures are not necessarily drawn to scale.

FIG. 1. Schematic of tri-methane reforming.

FIG. 2A-D. SEM images of Fresh 10% Cu alloyed on titania catalyst (A, B) and the spent catalyst (C, D).

FIG. 3A-C. (A, B) TEM EDX elemental analysis of copper alloyed alumina NWs (up to 20%) and (C) X-ray diffraction analysis of copper alloyed alumina NWs.

FIG. 4A-D. Nickel alloyed titania sample (8 wt %). A) SEM image analysis of fresh catalyst sample, B) XRD analysis of fresh catalyst sample, C) TEM EDX analysis of nickel alloyed titania sample, and D) Peak shift analysis of nickel alloyed titania sample.

FIG. 5A-D. SEM images of Fresh 8% Ni alloyed on titania catalyst (A, B) and the spent catalyst (C, D).

FIG. 6A-D. SEM images of Fresh 10% Ni alloyed on titania catalyst (A, B) and the spent catalyst (C, D).

FIG. 7A-E. SEM images of Fresh 10% Ni alloyed on alumina catalyst (A, B) and the spent catalyst (C, D). (E) Peak shift analysis of fresh catalyst.

FIG. 8A-B. (A, B) TEM EDX elemental analysis Zirconia alloyed titania NWs up to 8%.

FIG. 9A-B. Alloying of cobalt into the zinc oxide nanowires. A) X-ray diffraction analysis of ZnO NWs alloyed with cobalt nitrate precursor and B) SEM image analysis of zinc oxide nanowires alloyed with the cobalt precursor.

FIG. 10. Schematic of packed bed reactor and GC system used for the testing of dry methane reforming catalyst.

FIG. 11A-B. DMR reaction spent catalyst samples nickel alloyed and decorated titania NWs TGA analysis. (A) spent catalyst sample of nickel alloyed titania NWs and (B) spent catalyst sample of nickel decorated on titania NWs.

FIG. 12A-C. Nickel decorated titania NWs. (A) X-ray diffraction analysis of fresh catalyst sample and spent catalyst sample of the dry methane reforming reaction, (B) TEM EDX analysis of fresh catalyst sample, and (C) TEM EDX analysis of spent catalyst sample of the DMR testing.

FIG. 13A-E. Nickel alloyed titania NWs spent catalyst sample of DMR reaction. (A) SEM image analysis and (B) TEM image of spent sample. (C) X-ray diffraction analysis of spent sample in comparison with fresh sample, (D) EDX analysis of spent sample showing the distribution of nickel and titania, and (E) Exemplary DMR reaction mechanism on Ni alloyed titania NWs.

FIG. 14A-D. (A) Conversion of CO₂ for different catalysts at 700, 750, 800 and 850° C., (B) Conversion of CH₄ for different catalysts at 700, 750, 800 and 850° C., (C) Conversion of CO₂ over different amount of Ni alloyed into TiO₂ for over 500 h, and (D) Conversion of CO₂ over different amount of Ni alloyed into TiO₂ for over 500 h.

FIG. 15A-B. Nickel alloyed/decorated titania NWs sample DMR test performance (A) nickel alloyed sample and (B) Ni metal decorated on titania NWs, Methane and CO₂ conversion at different temperatures (at 750-850 deg C, GHSV of 60000 mlgr⁻¹h⁻¹, feed ratio of methane to carbon dioxide of 1).

FIG. 16. DMR reaction using 10% Ni—TiO₂ nanowire-based catalyst.

FIG. 17. DMR reaction using 10% Ni—MnO₂ nanowire-based catalyst.

FIG. 18. DMR reaction using monolith coated 10% Ni—TiO₂ nanowire-based catalyst (GHSV of 39 L/g·h).

FIG. 19. DMR reaction using monolith coated 10% Ni—TiO₂ nanowire-based catalyst (GHSV of 60 L/g·h).

FIG. 20. DMR reaction using monolith coated 10% Ni-TiO₂ nanowire-based catalyst (GHSV of 78 L/g·h).

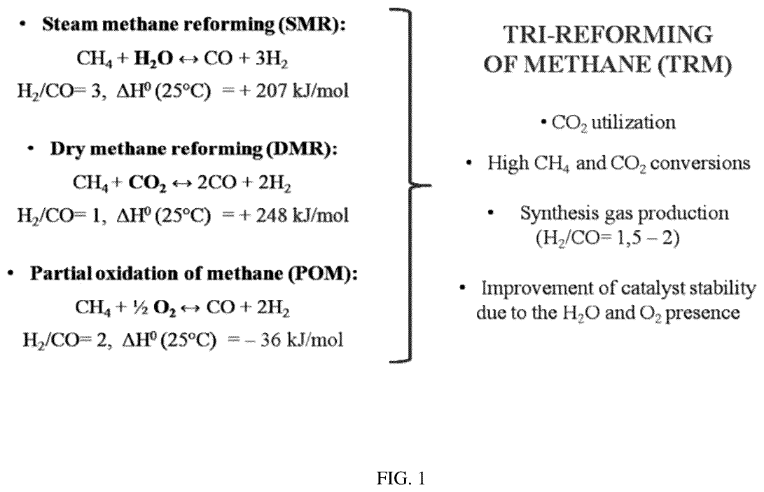

### DETAILED DESCRIPTION

The present invention is best understood by reference to the detailed figures, examples, and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

Embodiments of the present disclosure provide single atom or dual atom type catalysts in nanowire forms as durable and active catalysts for a variety of reforming reactions, such as dry methane reforming (DMR). As shown in the Examples, nickel alloyed titania (NiₓTi₁₋ₓO_{2-δ}), nickel alloyed alumina (Ni_{y}Al_{2-y}O_{3-δ}) and nickel alloyed manganese oxide (NiₓMn₁₋ₓO_{2-δ}) nanowires have shown durability, no coking and high activity with both dry methane reforming and tri-reforming under both thermal and plasma conditions, e.g. using microwave, radio-frequency, or dielectric barrier discharges. The catalyst activity of nickel alloyed into titania nanowires sample is >97% for CO₂ conversion and >86% for methane conversion and has been demonstrated to be stable for more than 500 hours without forming any coke or carbon on catalyst. Previous catalysts for DMR suffer from coking and deactivation and low activity. The formation of atomically dispersed sites helped with activation of methane and reduced the formation of coke.

Some embodiments provide a single atom dispersion of nickel or precious metals in titania, alumina, silica, tin oxide, or ZnO nanowires as catalyst materials in reforming applications involving hydrocarbons with either carbon dioxide as co-reactant or steam as co-reactant.

The catalysts disclosed herein are mixed metal oxide nanowires which may have the formula AₓB_{y}C_{1-x-y}O_{d} in which B is optional. Elements A and B are chosen either from transition metals or from precious metals, C is chosen from an earth abundant element (e.g. silicon, aluminum, titanium, zinc, and manganese), x and y are numbers greater than zero and less than 1 (e.g. 0.1, 0.15, 0.2, 0.25, 0.3, etc.), and d(δ) is a number greater than zero and is selected such that the formula has an overall charge of zero.

Transition metals are defined as elements whose atoms possess an incomplete d sub-shell or can give rise to cations (transition metal ions) with an incomplete d shell and include Groups 3 to 12 of the Periodic Table. Examples include, but are not limited to, nickel, iron, cobalt, and tungsten.

Precious metals are rare metallic clements including noble metals that are more corrosion resistant and less chemically reactive. Examples include, but are not limited to, platinum, ruthenium, iridium, rhodium, palladium, osmium, gold, and silver.

A nanowire is a nanostructure in the form of a wire having at least one diameter on the order of nanometers and an aspect ratio greater than 10:1. The “aspect ratio” of a nanowire is the ratio of the actual length (L) of the nanowire to the diameter (D). In some embodiments, the nanowire has a diameter of less than 300 nm, e.g. a diameter of 5-200 nm. In some embodiments, the nanowires described herein have a length of 0.5-20 microns or more.

Embodiments also provide compositions comprising the nanowire catalysts described herein. In some embodiments A and/or B are present in an amount of 100 ppm to 20 wt %, e.g. 100 ppm to 5 wt %, e.g. 1-20 wt %, e.g. 1-10 wt %. A catalyst composition may include the catalyst and one or more support, diluent, and/or binder materials.

Nanowire shaped catalysts may be incorporated into formed aggregates, such as pellets or extrudates, or coated onto structured supports. Nanowire aggregates forming a mesh type structure can have good adhesion onto rough surfaces. The nanowire catalysts may be formed in the shape of extrudates (e.g. a mesoporous extrudate) or pellets or disposed on various support structures, including honeycomb structures, grids, monoliths, and the like. An “extrudate” refers to a material (e.g., catalytic material) prepared by forcing a semisolid material comprising a catalyst through a die or opening of appropriate shape. Extrudates can be prepared in a variety of shapes and structures by common means known in the art. In some embodiments, the nanowire catalysts are made into extrudates and used directly in a packed bed for various reforming applications. The extrudates can be made highly porous allowing for high flow rates of gases. Nanowire materials when packed into agglomerates will allow for forming porous packings.

A “formed aggregate” refers to an aggregation of catalyst material particles, either alone, or in conjunction with one or more other materials, e.g., catalyst materials, dopants, diluents, support materials, binders, etc. formed into a single particle. Formed aggregates include without limitation, extruded particles, termed “extrudates”, pressed or cast particles, e.g., pellets such as tablets, ovals, spherical particles, etc., coated particles, e.g., spray, immersion or pan coated particles, impregnated particles, e.g., monoliths, foils, foams, honeycombs, or the like.

A “pellet” or “pressed pellet” refers to a material (e.g., catalytic material) prepared by applying pressure to (i.e., compressing) a material comprising a catalyst into a desired shape. Pellets having various dimensions and shapes can be prepared according to common techniques in the art.

In some embodiments, the catalyst material is coated on or impregnated in a monolith. A “monolith” or “monolith support” is generally a structure formed from a single structural unit preferably having passages disposed through it in either an irregular or regular pattern with porous or non-porous walls separating adjacent passages. Examples of such monolithic supports include, e.g., ceramic or metal foam-like or porous structures. The single structural unit may be used in place of or in addition to conventional particulate or granular catalysts (e.g., pellets or extrudates). Examples of such irregular patterned monolith substrates include filters used for molten metals. Monoliths generally have a porous fraction ranging from about 60% to 90% and a flow resistance substantially less than the flow resistance of a packed bed of similar volume (e.g., about 10% to 30% of the flow resistance of a packed bed of similar volume). Examples of regular patterned substrates include monolith honeycomb supports used for purifying exhausts from motor vehicles and used in various chemical processes and ceramic foam structures having irregular passages. Many types of monolith support structures made from conventional refractory or ceramic materials such as alumina, zirconia, yttria, silicon carbide, and mixtures thereof, are well known and commercially available from, among others, Corning, lac.; Vesuvius Hi-Tech Ceramics, Inc.; and Porvair Advanced Materials, Inc. and SiCAT. Monoliths include foams, honeycombs, foils, mesh, gauze and the like.

The catalytic materials may optionally comprise a dopant. In this respect, doping material(s) may be added during preparation of the individual components, after preparation of the individual components but before drying of the same, after the drying step but before calcinations or after calcination. Dopants may also be impregnated into, or adhered onto formed aggregates, or as layers applied upon supports for formed aggregates, prior to addition of one or more different materials, e.g., catalyst materials, diluents, binders, other dopants, etc.

The catalytic materials may be incorporated into a reactor bed for performing any number of catalytic reactions. Accordingly, in one embodiment the present disclosure provides a catalytic material as disclosed herein in contact with a reactor and/or in a reactor bed. For example, the reactor may be a fixed/packed bed reactor. In this regard, the catalytic material may be packed neat (without diluents) or diluted with an inert material (e.g., sand, silica, alumina, etc.) The catalyst components may be packed uniformly forming a homogeneous reactor bed. In some embodiments, nanowire catalysts can directly be used in fluidized beds. Nanowires with lengths exceeding a few microns can easily be fluidized and the entrained materials can be captured using bag house filters. Due to one dimensional geometry, the hydraulic radius will be based on length scale. The use of nanowire catalysts in fluidized bed reactors will allow for high throughput gas reforming and high activity.

Further embodiments provide methods for preparing nanowire catalysts, e.g. as described in the Examples. In particular, the method may include steps of mixing a binary oxide nanowire powder having element C with a precursor of element A to form a mixture; drying the mixture; and calcining the mixture to provide the nanowire catalyst. The precursor may be, for example, an acetate, formate, oxalate, or nitrate precursor. The calcining step may be performed at a temperature of 200-600° C., e.g. 250-500° C. for 0.1-5 hours, e.g. 0.5-3 hours. The calcining step may be performed under inert or vacuum conditions.

The nanowire catalysts are useful in methods for dry methane reforming. The method may include reacting CO₂ and CH₄ in the presence of the nanowire catalyst to produce CO and H₂. In some embodiments, a ratio of CO₂ to CH₄ is from 2:1 to 1:2. The method may be performed at a temperature of 500-1000° C., e.g. 700-900° C. In some embodiments, the method may be performed under plasma conditions, e.g. in a plasma discharge reactor. The method may be performed using microwave plasma or dielectric barrier discharge using low frequency electric fields, e.g. as described in U.S. Pat. Nos. 11,591,226 and 11,103,848 incorporated herein by reference. The nanowire catalysts described herein have shown high durability, no coking, and high activity under both thermo-catalytic and plasma-catalytic conditions. In some embodiments, the method is performed in a reactor comprising a packed catalyst bed and the catalyst is in an extrudate form or is coated on monoliths. In some embodiments, the method is performed in a reactor comprising a fluidized catalyst bed and wherein the catalyst is fluidized.

The nanowire catalysts are also useful in methods for bi-reforming of methane which includes reacting CO₂, CH₄, and H₂O in the presence of the nanowire catalyst to produce CO and H₂. The nanowire catalysts are useful in methods for tri-reforming of methane which includes reacting CO₂, CH₄, H₂O, and O₂ in the presence of the nanowire catalyst to produce CO and H₂.

Before exemplary embodiments of the present invention are described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The invention is further described by the following non-limiting examples which further illustrate the invention, and are not intended, nor should they be interpreted to, limit the scope of the invention.

EXAMPLE 1. Synthesis of AₓB_{y}C_{1-x-y}O_{d} Nanowires: The procedure is as follows: First, binary oxide nanowire powders involving element, C, are obtained and mixed with precursors (acetate, formate or nitrate) of elements A and/or B at appropriate proportions and then dried at 80 deg C followed by calcining at temperatures ranging from 300-500 deg C under inert or vacuum conditions for 0.5-3 h. During calcination, a slight flow of inert gas (either at atmospheric pressure with complete inert environment or low pressure) is maintained to remove the by-product gases. The nanowire materials are about a few microns (0.5-100 microns) in length with diameters ranging from 10-200 nm. X-ray diffraction analysis will indicate proper alloying of elements, A, and B into original nanowires through shift of the diffraction peaks from the original nanowires. TEM EDX elemental analysis on fresh catalysts indicates that the nickel is distributed uniformly throughout nanowires.

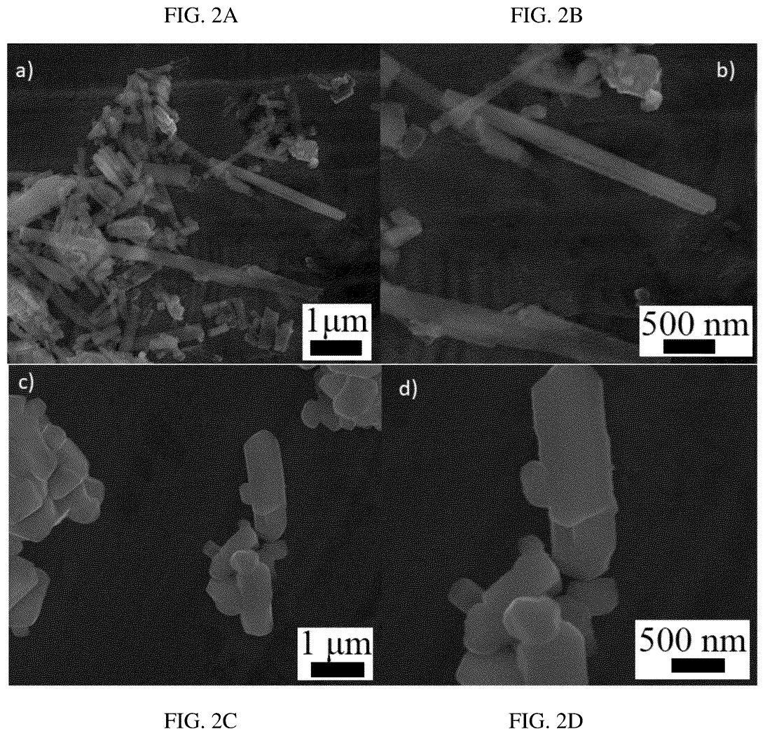

EXAMPLE 2. Cu alloyed TiO₂ nanowires (CuₓTi₁₋ₓO_{2-d} nanowires): Copper alloying experiments with titania nanowires were performed using the following simple procedure. First, titania nanowires were mixed with the copper nitrate precursor dissolved in water. The amount of nitrate precursor was determined based on the amount of copper alloying desired in nanowires. Several experiments were conducted using different amounts of copper nitrate precursors toward obtaining titania nanowires with composition of copper ranging from 2 at % to 15 at % to that of titania NWs. Second, the precursor materials were dried at 80 deg C for 1 h. Finally, the dried materials were exposed under the inert atmosphere at 500 deg C for 1 h. SEM images in FIGS. 2A-D show that nanowire morphology is retained even after the alloying reaction. The average diameters of nanowires ranged from 150 to 200 nm and lengths ranged from 1 to 2 microns. So, there were no morphological changes to the alloyed nanowires compared to original titania nanowires.

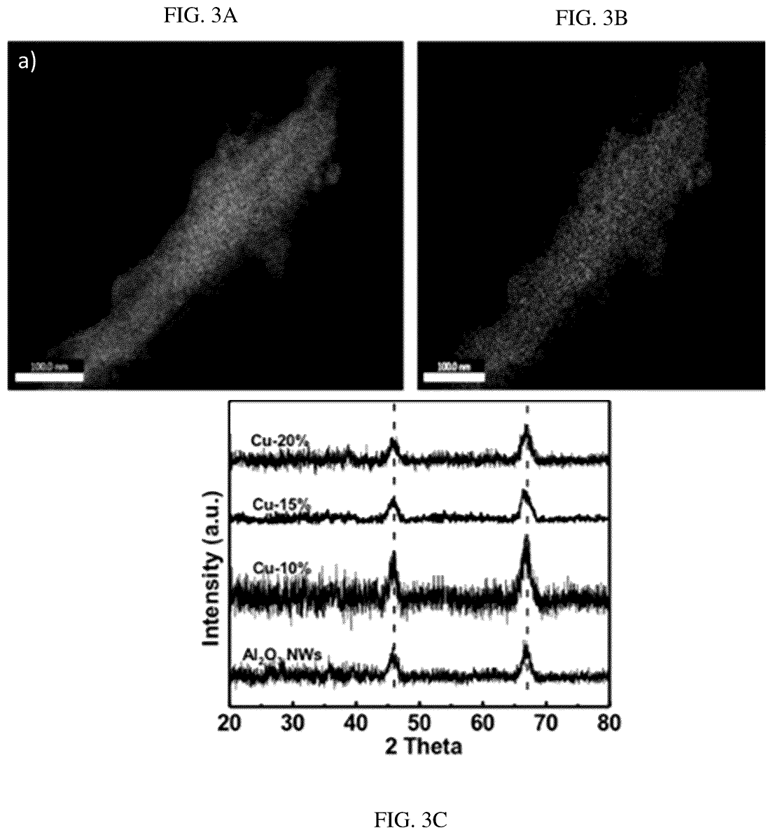

EXAMPLE 3. Cu alloyed Al₂O₃ nanowires (CuₓAl₂₋ₓO_{3-d} nanowires): Alumina NWs dimensions are relatively smaller in comparison to the titania NWs. So, several experiments on alumina NWs were conducted to understand the effect of smaller dimensions of nanowires on the thermodynamic solubility limits at smaller nanowire diameters. FIGS. 3A-C show the images of porous alumina alloyed with the copper precursor. Porous alumina nanowires were alloyed with copper precursor using a procedure like that described for titania NWs carlier. The resulting alloyed nanowires were characterized using X-ray diffraction analysis and TEM EDX elemental analysis. The results confirmed that the uniform alloying of copper into alumina NWs with no signs of the copper oxide secondary phase formation. Furthermore, copper alloying is extended up to 18 at % in alumina nanowires in comparison to titania nanowires at 8 at %. This could be attributed to the reduced dimensions of (diameter of 20-50 nm) of alumina NWs in comparison to the diameter of titania NWs (150-200 nm diameter). Moreover, the thermodynamic phase diagrams of CuO—TiO₂ and CuO—Al₂O₃ systems at 500 deg C indicate non-existence of solid solutions^{3, 4}. So, the results obtained here clearly show an extended solubility in nanowires than that of bulk materials. This could be attributed to the available higher surface energy at the nanowire surface. Higher surface energy of nanoscale surfaces promotes alloying with solutes. Increased concentration of solutes at surfaces leads to diffusion of solutes into bulk of the nanowires. As the length scales between pores are as small as a few nanometers, the surface alloying leads to re-distribution of solute uniformly into nanowires. The net effect is that the increased surface energy of nanowires leads to increased dissolution of solutes into nanowires.

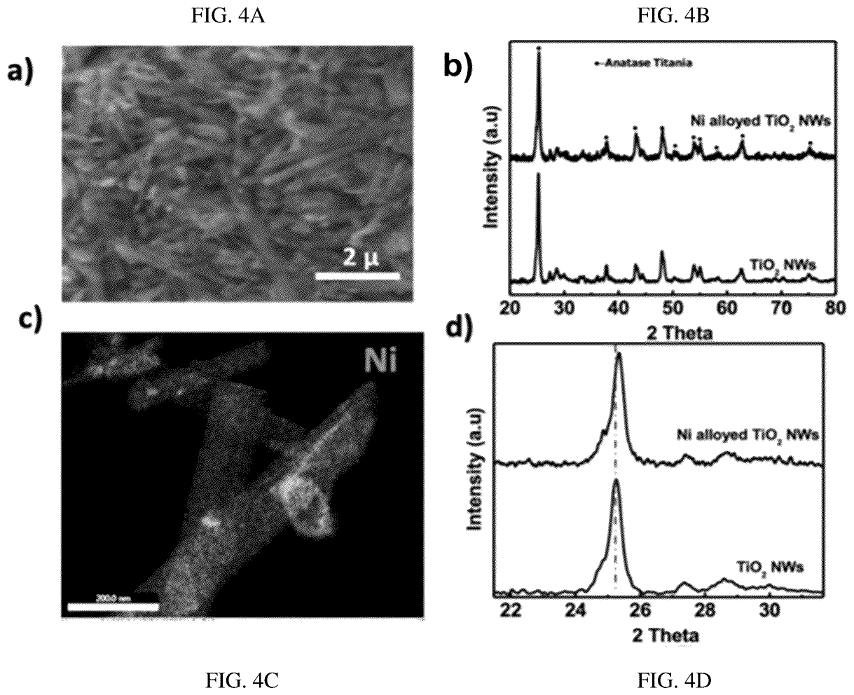

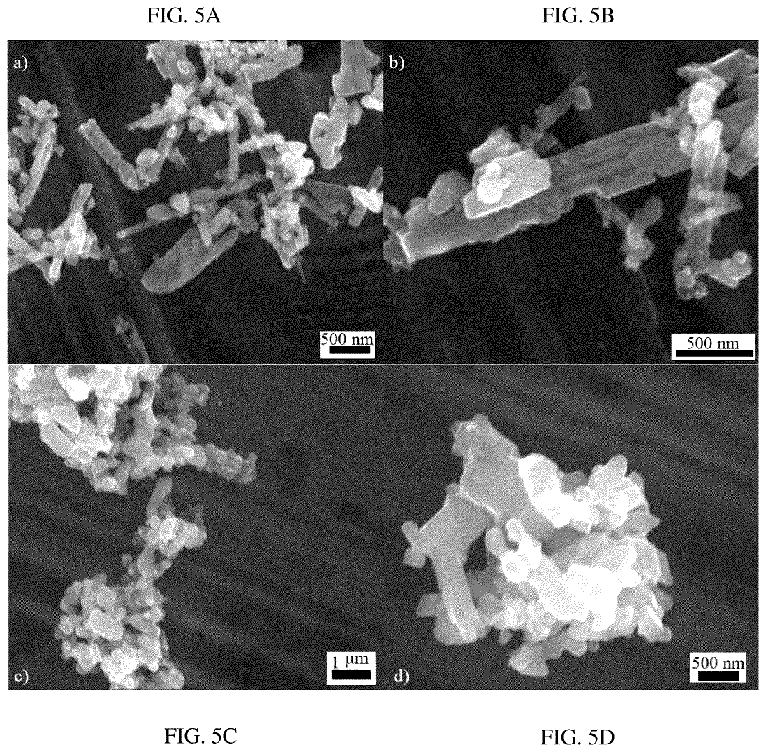

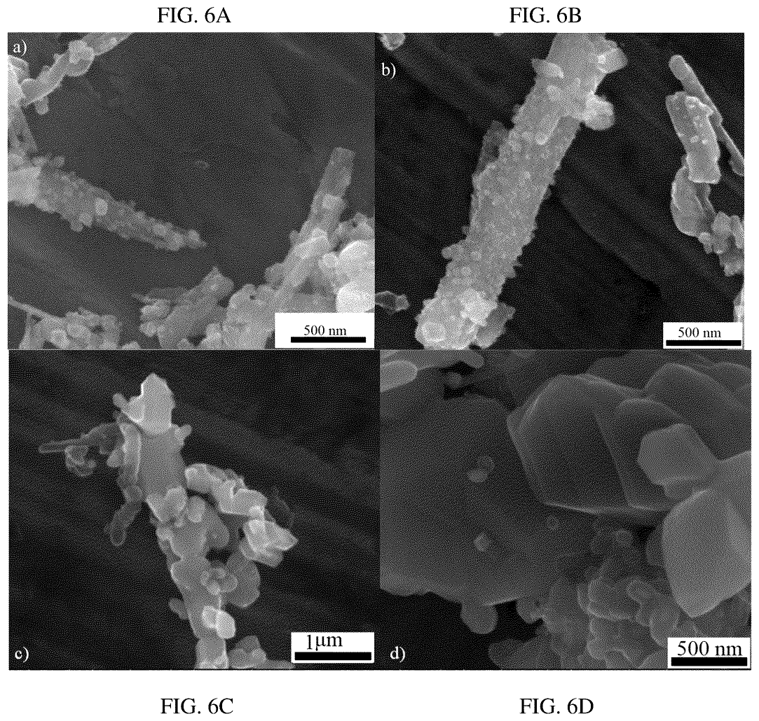

EXAMPLE 4. Ni alloyed TiO₂ nanowires (NiₓTi₁₋ₓO_{2-d} nanowires): The samples of nickel alloyed titania nanowires were prepared by mixing desired quantities of nickel nitrate with titania nanowires followed by drying at 80 deg C, calcining at 500 deg C under inert conditions for 1 h to synthesize nickel alloyed titania NWs. Materials analysis was performed using the scanning electron microscope to show morphology of nanowires with the lengths around 4-6 micron and 150-200 nm in diameter (FIG. 4A). Furthermore, X-ray diffraction pattern (FIG. 4B) reveals that the fresh catalyst only contains the phase of titania anatase as major phase. No nickel oxide peaks are seen suggesting nickel is alloyed into titania nanowire and no segregated nickel oxide particles are present in the materials. Also, XRD peak shift in titania peaks (FIG. 4D) are observed after the alloying indicates that there are changes in the titania lattice. From the TEM EDX analysis (FIG. 4C) the Ni alloyed into titania nanowires can be seen dispersed uniformly all along the nanowire material. The presence of Ni in the TEM elemental mapping and the absence of Ni peaks in the XRD data indicate that Ni is dispersed atomically. The SEM images of Fresh catalysts with 8% Ni (FIG. 5A-B) and 10% Ni (FIG. 6A-B) show that the nanowire morphology of TiO₂ is still intact. The SEM images of the spent catalysts after reforming reaction at 850° C. for 24 hours (8% Ni (FIG. 4C-D) and 10% Ni (FIG. 6C-D) still show the nanowire morphology of the alloyed material.

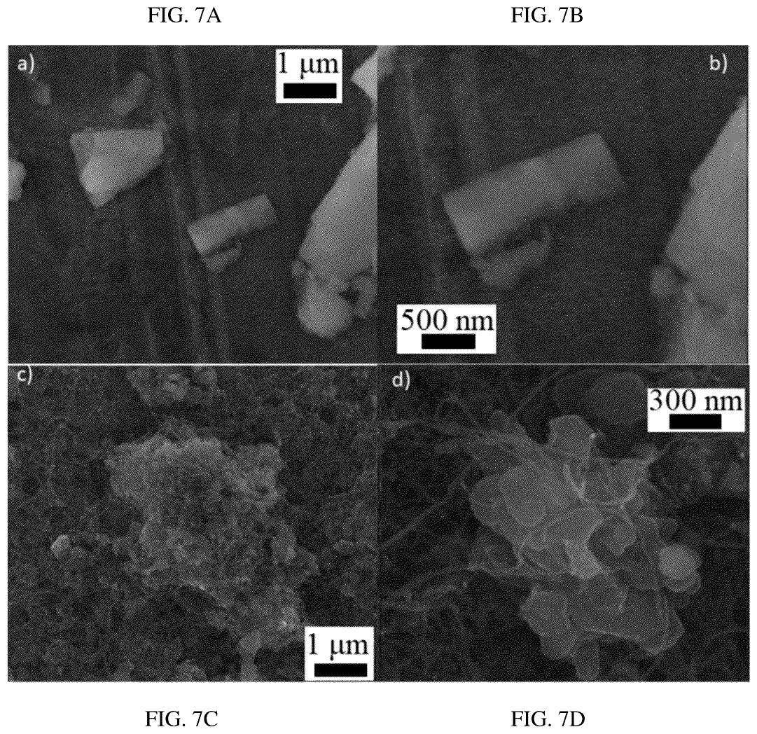

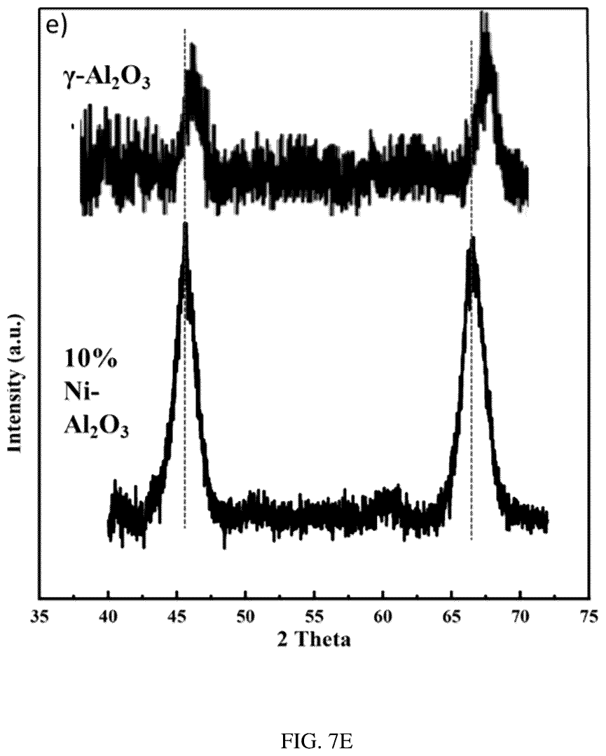

EXAMPLE 5. Ni alloyed Al₂O₃ nanowires (NiₓAl₂₋ₓO_{3-d} nanowires): Alumina NWs dimensions are relatively smaller in comparison to the titania NWs. So, several experiments on alumina NWs were conducted to understand the effect of smaller dimensions of nanowires on the thermodynamic solubility limits at smaller nanowire diameters. FIGS. 7A-B show the images of porous alumina alloyed with the nickel precursor. The alloyed material shows the nanowire morphology which is previously seen for alumina nanowires. Porous alumina nanowires were alloyed with nickel precursor using a procedure described previously for titania NWs. The resulting alloyed nanowires were characterized using X-ray diffraction analysis. The extended solubility in nanowires than that of bulk materials is attributed to the higher surface energy at the nanowire surface as described previously. The alloying of the materials is confirmed from the XRD data (FIG. 7E) where Al₂O₃ peaks are shifted. The spent catalyst material had lost its nanowire morphology and carbon nanotubes can also be seen deposited on the material (FIGS. 7C-D). This is because of the phase transformation of alumina nanowires which were not initially treated at high temperatures of 850° C. and the reforming reaction caused the deposition of carbon in the form of nanotubes because of phase transformation of alumina.

EXAMPLE 6. Zr alloyed TiO₂ nanowires (ZrₓTi₁₋ₓO_{2-d} nanowires): It is reported that the thermodynamic solubility of zirconium into titania is very limited. So, experiments involving zirconium (ionic radii—0.72 A°) alloying into titania nanowires were performed to understand the solubility at nanoscale. TEM EDX elemental analysis on a titania nanowire shows that it is alloyed with zirconium alloyed up to 8 at %. It is reported that the zirconium thermodynamic solubility in titania very low. Zirconia is thermodynamically soluble up to 5 at % in titania at 1700 deg C from the thermodynamic phase diagrams. Also, ex-situ alloying of zirconia using thin uniform coating of zirconium around titania nanowires were attempted in the literature and only a trace amount of zirconia is found to be alloyed into the titania NWs.

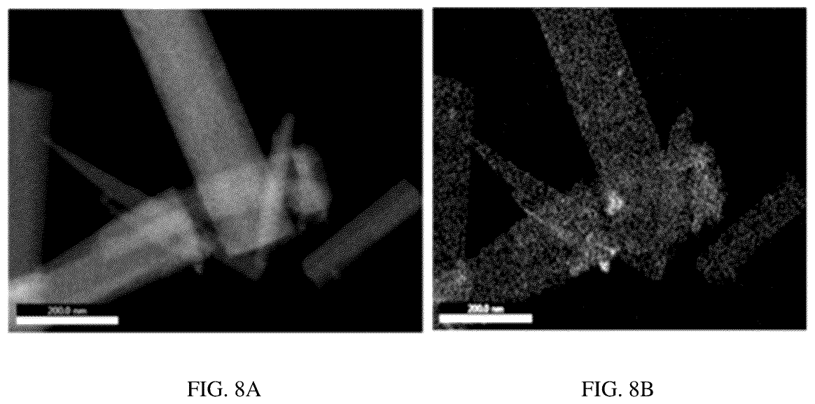

Similarly, experiments were also conducted on solid state alloying of solutes in to zinc oxide nanowires to understand solubilities at nanoscale. FIGS. 8A-B show images of TiO₂ NWs alloyed with zirconium precursor.

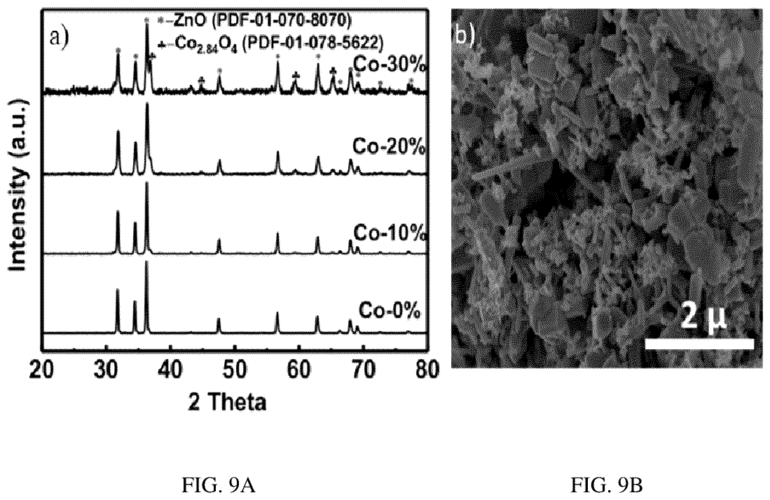

EXAMPLE 7. Co alloyed ZnO nanowires (CoₓZn₁₋ₓO_{1-d} nanowires): In FIGS. 9A-B, solid state alloying of cobalt into the zinc oxide nanowires was carried out using the cobalt nitrate precursor and zinc oxide nanowires as the solvent phase. The experiment was conducted at a temperature of 500 deg C for 1 h under the inert atmosphere. From the X-ray diffraction analysis, it is noticed that the cobalt is alloyed up to the nominal composition of 20 at % cobalt nitrate; beyond that composition there is a segregation of cobalt oxide observed. SEM image analysis shows that the nanowire morphology still retained after the alloying process. Higher amount of alloying of up to 20 at % of cobalt into the zinc nanowires seems possible. Such high concentrations are probably duc to higher thermodynamic solubility limit expected for cobalt in the zinc oxide at nanoscale.

EXAMPLE 8. Reforming reactions: Reforming reactions included dry methane reforming using methane and carbon dioxide at 1:1 and also at various ratios at high temperatures (750-850 C); bi-reforming using methane, carbon dioxide, steam at temperatures ranging from 700-850 C; and tri-reforming reactions using methane, carbon dioxide, steam and oxygen at temperatures ranging from 700-850 C. In addition to thermally activated reforming reactions, these experiments were also conducted using plasma excitation conditions using microwave plasma and dielectric barrier discharge using low frequency electric fields. Alloyed nanowire materials have shown high durability, no coking and high activity under both thermo-catalytic and plasma-catalytic conditions.

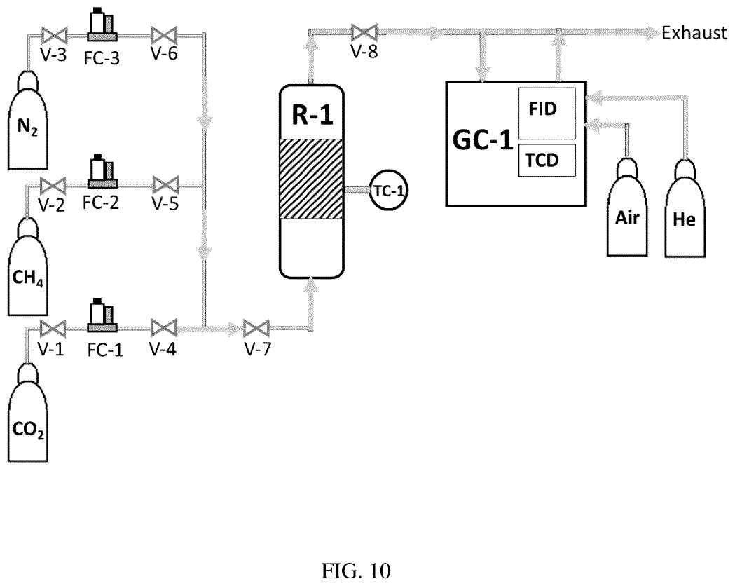

EXAMPLE 9. Experimental procedure of the DMR (dry methane reforming) reaction: Dry methane reforming reaction is performed in a packed bed quartz tube reactor aligned with the vertical furnace and connected by mass flow controllers, gas chromatography (GC). The gas composition is controlled by the mass flow controllers calibrated with He, H₂, CO₂ and CH₄ gases. The outlet stream is partly injected into the GC valve to identify the unreactive gases and products as shown in FIG. 10. The reaction conditions of temperature range from 700-850 deg C, at atmospheric pressure, with 0.5 g catalyst powder, with an GHSV (gas hourly space velocity) of 6-12 Lg⁻¹h⁻¹ of reactive gases CH₄—25-50 sccm, CO₂—25-50 sccm, and nitrogen as unreactive gas with flowrate of 15 sccm feed to the reactor. The typical process includes packing the catalyst into the quartz tube reactor using the glass wool as support followed by heating the furnace with the flow of nitrogen through the reactor at 20 sccm. The temperature is raised at a ramp rate of 10 deg/min after reaching the reaction temperature conditions reactant gases are flown through the reactor. Part of the product stream is injected into the GC and the remaining gas stream is flown though the exhaust.

The GC system is an Agilent 7820A instrument with a thermal conductivity detector (TCD) and a flame ionization detector (FID) with a Shin Carbon ST micro packed column (100/120 mesh, 2 m, 1/16 in. OD, 1.0 mm ID). The GC analysis is performed under a flow of 10 ml/min of He as carrier gas and heating program (40° C. for 2 min, 10° C./min heating to 220° C. and hold for 3 min). The catalytic activity is checked at each temperature for 24 hours and the average values after stabilizing are reported. For testing the catalysts, approximately 500 mg of catalyst is loaded into a fixed bed reactor. The desired temperature of the catalyst is obtained in nitrogen flow and then the gases are switched to CH₄:CO₂:N₂=5:5:3 with a total flow rate of 65 ml/min.

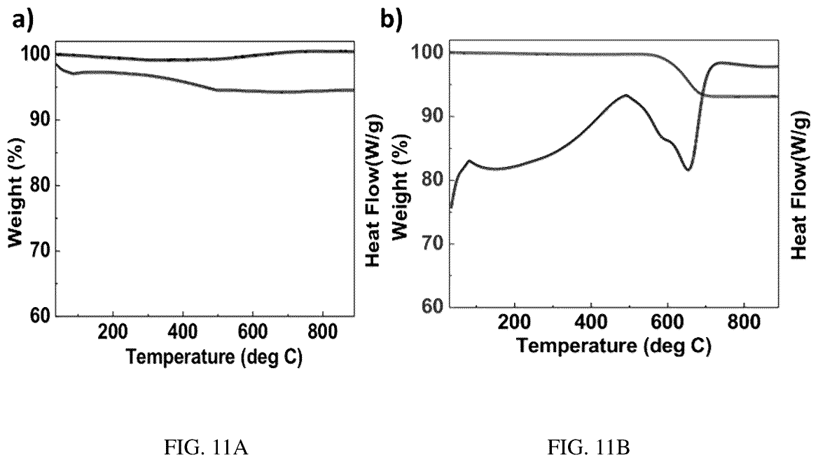

EXAMPLE 10. DMR test spent catalyst material analysis: Furthermore, thermogravimetric analysis (TGA) was performed on the spent materials to quantify and characterize the carbon deposits formed in both supports. A starting weight of approximately 20 mg was placed in a porcelain cup in the SDT-Q600 instrument. The sample was heated up to 1000° C. using a heating rate of 10° C. per minute under the air flow of 100 ml/min. From FIGS. 11A-B, TGA analysis on the alloyed samples have not shown any change in weight indicating the absence of carbon deposition. On the other hand, TGA analysis from the nickel decorated titania nanowires shows a decrease in weight from temperatures at 508 deg C and stabilized at around 726 deg C. The observed weight loss is due to burning of coke formed on the catalyst.

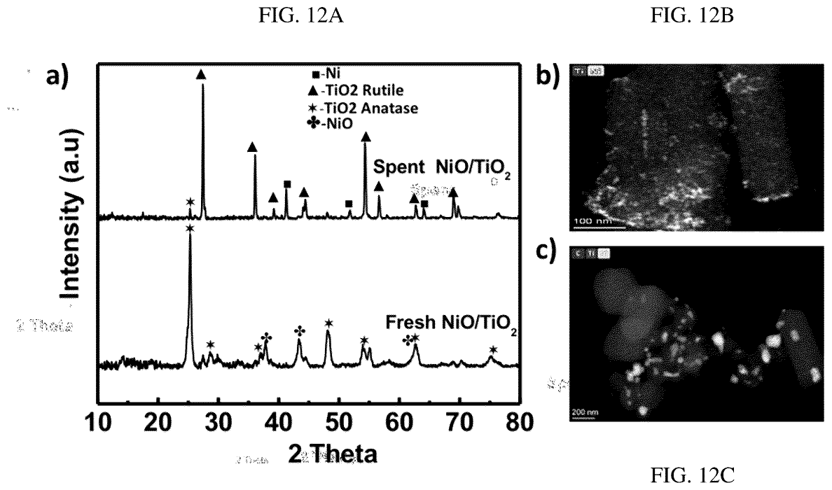

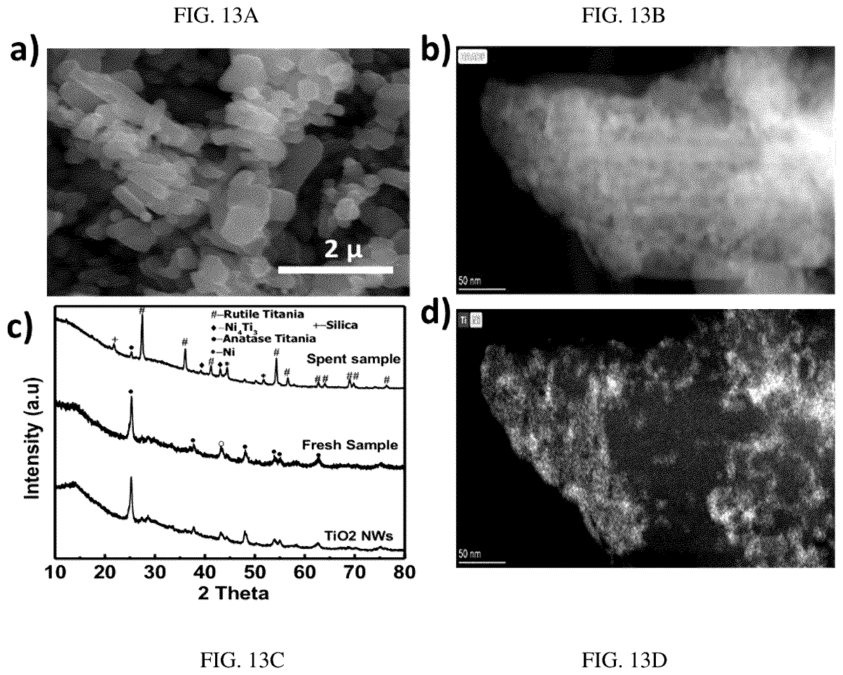

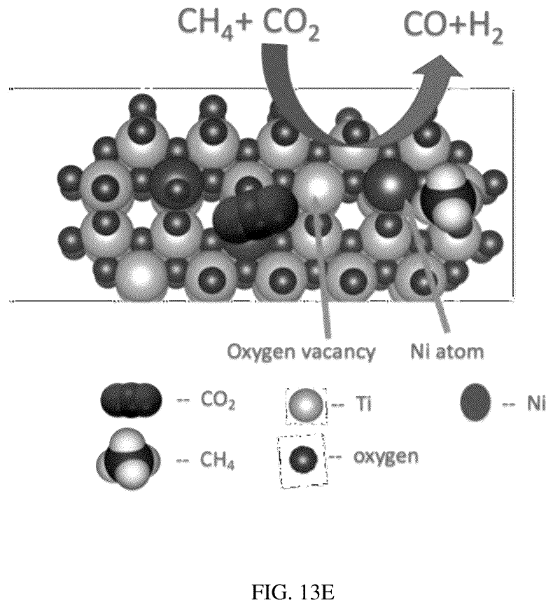

Several characterization analyses such as SEM image analysis, X-ray diffraction analysis and TEM EDX analysis were performed on both the alloyed and supported catalysts to understand the catalyst durability. The XRD analysis of fresh and spent sample of nickel decorated catalyst shows that there is change of phase of titania from anatase to rutile (FIG. 12A). Also, the nickel oxide in the fresh sample is converted to the nickel metal during the reduction reaction. TEM EDX analysis on the fresh sample shows well dispersed nickel on the titania NWs and absence of carbon. However, the spent sample contains larger sintered nickel particles along with carbon deposits. In contrast, the SEM image of nickel alloyed titania spent sample in FIG. 13A, shows that the nanowire morphology is still retained even after the 50 h on the stream. Also, X-ray diffraction analysis shows the presence of alloy phase of Ni₄Ti₃. Moreover, the TEM EDX analysis clearly indicates there is no coke deposit in the spent sample and nickel is distributed uniformly throughout nanowires like that of fresh sample. The alloyed sample with no carbon deposition and no changes with structure suggest durability with performance compared to supported catalyst. In the case of supported nanowire catalysts, the deposition of carbon could block the active sites of the catalyst sample and the sintering nickel particles could heavily promote the coke deposition. Also, it is observed that there is a slight decrease in the performance of nickel supported catalyst as the reaction proceeds. This could further support the argument of catalyst surface is modified compared to the fresh catalyst. The contemplated mechanism of alloyed catalyst is shown in FIG. 13E. Nickel alloying in titania could create the oxygen vacancies on the titania surface. This could provide the surface with oxygen vacancy next to the nickel atom. This synergy on the titania nanowire surface could enhance performance of the catalyst. As shown in FIG. 13E, the carbon dioxide could chemisorb on the oxygen vacant site and on the methane molecule and could react on the nickel surface. The reported data shows that the activation of methane on the nickel surface is the rate limiting step in the DMR reaction. Ni site along with oxygen vacancy could lead to dual atom type catalyst. The synergy of Ni alloying into the titania NWs is contributing to the higher performance of the catalyst. The effect of temperature on the activity of catalyst is given in the below tables. The catalytic activity is checked at each temperature for 24 hours and the average values after stabilizing are reported.

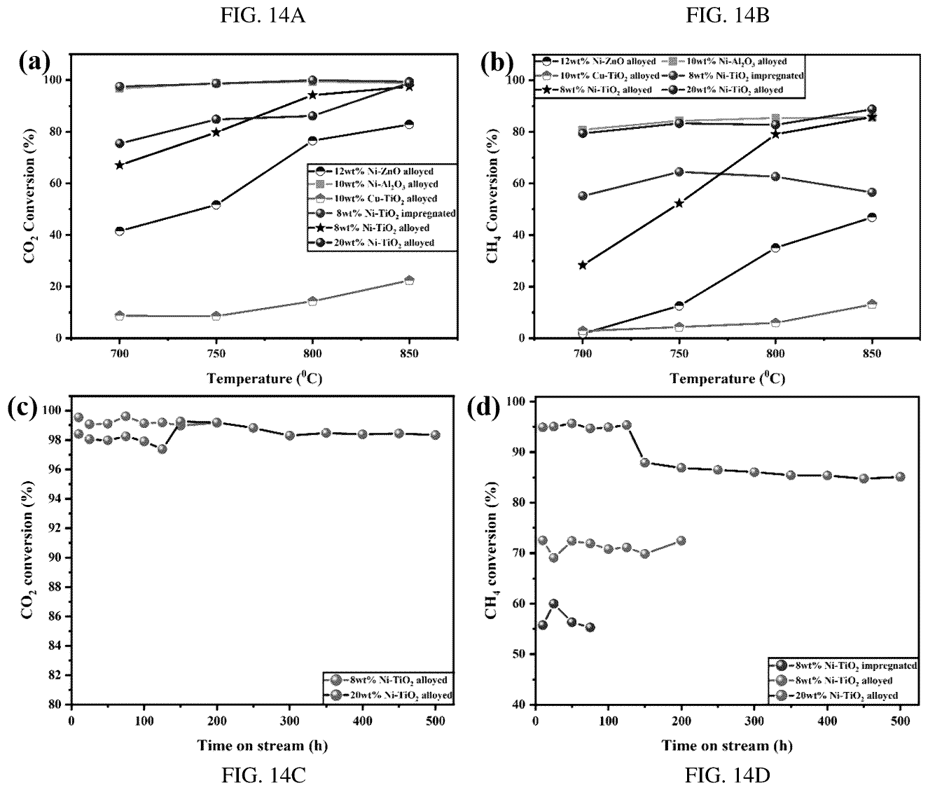

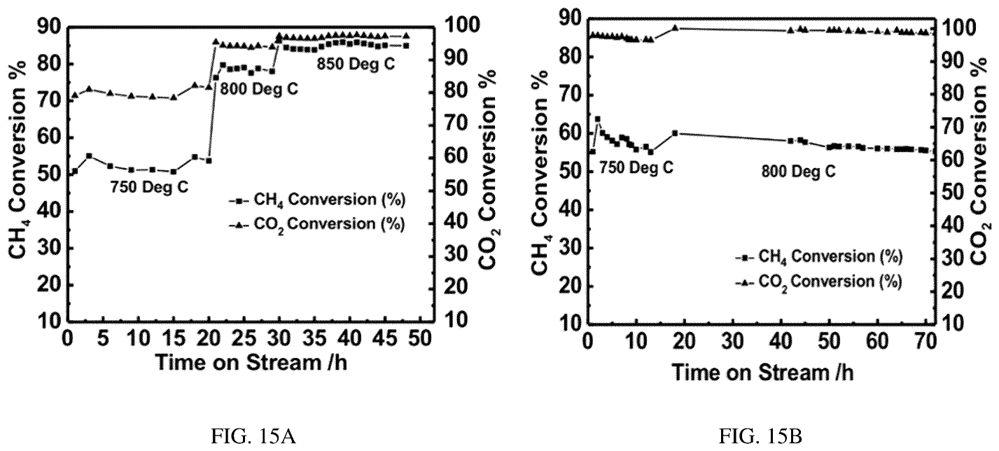

EXAMPLE 11: Different formulations using Ni with TiO₂ NWs, Al₂O₃ NWs and ZnO NWs are tested at different temperatures for 24 hours. The reactor is loaded with 0.5 g of catalyst material. The reactant gas flow rate is set at 7800 LKg⁻¹H⁻¹ (CH₄:CO₂:N₂=5:5:3). Four different temperatures of 700, 750, 800 and 850° C. are tested. Four different formulations of Ni, 8 wt % and 20 wt % with TiO₂ NWs, 10 wt % with Al₂O₃ NWs and 12 wt % with ZnO NWs are tested at the mentioned temperatures. One formulation comprises 10 wt % Cu with TiO₂ NWs. The CO₂ conversions for the different formulations at 700° C., 750° C., 800° C. and 850° C. are given in Table 1. The CH₄ conversions for the different formulations at the mentioned temperatures are given in Table 2. The data is also shown in FIGS. 14A-D and 15A-B. The data in FIG. 15 show contrasting difference with performance of alloyed nanowires versus nanowires decorated with metallic clusters.

EXAMPLE 12: Two different compositions of Ni alloyed with TiO₂ NWs were tested for activity using the above-mentioned testing method at 850° C. 8wt % Ni—TiO₂ and 20 wt % Ni—TiO₂ formulations with Ni are tested for 200 hours and 500 hours respectively. They showed a CO₂ conversion of 99.16% after 200 hours time on stream for the 8 wt % catalyst and 98.33% after 500 hours on stream for the 20 wt % catalyst (Table 3). The CH₄ conversion for the 8 wt % Ni—TiO₂ catalyst is 72.46% and 85.10% for the 20 wt % Ni—TiO₂ (Table 4). The data is represented in FIG. 14. The alloyed catalyst is tested for different GHSV values and the results are shown in Table 5. The CH₄ and CO₂ conversions did not change very much and are above 95% even after doubling and 1.5 times the optimal GHSV.

EXAMPLE 13. Comparison with results presented in the literature: Table 6 shows the comparison of the performance with the recently reported catalysts in literature for methane reforming reactions. The catalysts described here are Ni based catalysts with different supports such as Ceria, Magnesium oxide, Silica, silica doped with ceria and hydroxyapatite doped with Ce. The stability of catalyst was improved through doping the support as in the case of Akri et al⁵ or by using sandwich structure where Ni is incorporated between the narrow regions of the kaolinite support⁶. The reaction conditions are changed to increase the activity by using microwave irradiation, which can decrease the bulk reaction temperature due to formation of localized hotspots⁷. The catalyst reported is very sensitive to the reactant gas composition. The catalyst used for the reaction is Ni/La supported on active carbon and with the increase of CH₄ composition the carbon deposition increases rapidly which leads to the decrease in porosity of the material and thus decreased CO₂ conversion. The reaction was also conducted using dilute stream of reactants with composition of 3:3:14 of CO₂:CH₄:N₂. The most stable catalyst reported is Ni—Mo supported on single crystalline MgO, which showed high conversion of ˜98% for CO₂ and CH₄ for over 850 hours. The same active metal did not show any activity if the structure of the support is different, meaning an amorphous or multi-crystalline MgO having the same active metals of Ni and Mo did not show the same activity. The feed gas used in the report is a diluted stream in the ratio of 1:1:8 CO₂:CH₄:N₂, and analysis using concentrated stream of reactant gases as in the present disclosure is not reported.

EXAMPLE 14. Plasma-catalytic tri-reforming: The catalysts developed also show high stability when used for tri reforming reaction with MW plasma. Table 7 shows the results of tri reforming experiments at the same mole ratio and MW power (1050 W) without and with catalyst. The effect of insulating the reactor at different areas on the formation of carbon in the reactor is also checked. With no insulation on the reactor, the carbon radicals getting formed in the reaction started getting deposited on the colder regions which are reactor surface and rest of the system. To avoid losing the radicals and to reduce the carbon deposition on the reactor surface and in the system, different experiments by putting the insulation on different areas of the reactor were conducted. The least carbon deposition was observed when just the catalyst bed area was insulated.

TABLE 1
Catalyst activity with CO₂ conversion during dry
methane reaction at different temperatures.
CO₂ Conversion (%)

| | Activity at temperature (° C.) | | | |
|---|---|---|---|---|
| Catalyst | 700 | 750 | 800 | 850 |
| 8 wt % Ni—TiO₂ (alloyed) | 67.03 | 79.70 | 94.20 | 97.46 |
| 20 wt % Ni—TiO₂ (alloyed) | 75.42 | 84.76 | 86.10 | 98.48 |
| 10 wt % Ni—Al₂O₃ (alloyed) | 96.78 | 98.84 | 99.39 | 98.93 |
| 12 wt % Ni—ZnO (alloyed) | 41.48 | 51.67 | 76.51 | 82.81 |
| 10 wt % Cu—TiO₂ (alloyed) | 8.73 | 8.58 | 14.34 | 22.38 |

### Table 2. Catalyst Activity with Methane Conversion during Dry Methane Reaction at Different Temperatures

### Mehtane Conversion (%)

TABLE 3
Catalyst activity (CO₂ conversion) as a function of time on stream at 850° C.

Activity at temperature (° C.)

| Catalyst | 700 | 750 | 800 | 850 |
|---|---|---|---|---|
| 8 wt % Ni—TiO₂ (impregnated) | 55.17 | 64.51 | 62.63 | 56.55 |
| 8 wt % Ni—TiO₂ (alloyed) | 28.30 | 52.27 | 79.05 | 85.75 |
| 20 wt % Ni—TiO₂ (alloyed) | 79.41 | 83.27 | 82.74 | 88.74 |
| 10 wt % Ni—Al₂O₃ (alloyed) | 80.86 | 84.29 | 85.37 | 85.51 |
| 12 wt % Ni—ZnO (alloyed) | 1.78 | 12.59 | 35.06 | 46.86 |
| 10 wt % Cu—TiO₂ (alloyed) | 2.89 | 4.36 | 5.94 | 13.15 |

| | Activity with time | | | | | | | | | | | | | |
|---|---|---|---|---|---|---|---|---|---|---|---|---|---|---|
| Catalyst | 10 | 25 | 50 | 75 | 100 | 125 | 150 | 200 | 250 | 300 | 350 | 400 | 450 | 500 |
| 8 wt % | 99.53 | 99.07 | 99.10 | 99.61 | 99.12 | 99.19 | 98.97 | 99.16 | | | | | | |
| Ni—TiO₂ | | | | | | | | | | | | | | |
| (alloyed) | | | | | | | | | | | | | | |
| 20 wt % | 98.40 | 98.04 | 97.97 | 98.24 | 97.90 | 97.36 | 99.25 | 99.19 | 98.81 | 98.29 | 98.47 | 98.38 | 98.43 | 98.33 |
| Ni—TiO₂ | | | | | | | | | | | | | | |
| (alloyed) | | | | | | | | | | | | | | |

CO₂ Conversion (%)

TABLE 4
Catalyst activity (methane conversion) as a function of time on stream at 850° C.

| | Activity with time | | | | | | | | | | | | | |
|---|---|---|---|---|---|---|---|---|---|---|---|---|---|---|
| Catalyst | 10 | 25 | 50 | 75 | 100 | 125 | 150 | 200 | 250 | 300 | 350 | 400 | 450 | 500 |
| 8 wt % | 72.53 | 69.08 | 72.40 | 71.89 | 70.78 | 71.13 | 69.86 | 72.46 | | | | | | |
| Ni—TiO₂ | | | | | | | | | | | | | | |
| (alloyed) | | | | | | | | | | | | | | |
| 20 wt % | 94.90 | 95.04 | 95.69 | 94.68 | 94.89 | 95.35 | 87.89 | 86.87 | 86.48 | 86.03 | 85.41 | 85.36 | 84.73 | 85.10 |
| Ni—TiO₂ | | | | | | | | | | | | | | |
| (alloyed) | | | | | | | | | | | | | | |

### Methane Conversion (%)

TABLE 5
Catalyst activity for 8 wt % Ni—TiO₂ as
a function of GHSV at 800° C.

| | Activity at GHSV (L/Kg h) | | |
|---|---|---|---|
| | 7800 | 12000 | 18000 |
| CO₂ conversion | 99.16 | 99.57 | 99.64 |
| CH₄ conversion | 99.18 | 97.63 | 98.49 |

TABLE 6
Comparison of different catalysts reported in literature

| Catalyst and | Reaction | | CO₂ | CH₄ | | |
|---|---|---|---|---|---|---|
| operating | temperature | TOS | conversion | conversion | | |
| temperature | (° C.) | (h) | or activity | or activity | Comments | Reference |
| 2 wt % Ni on 5 | 750 | 100 | ~95% | 90% | The activity of the catalyst | ⁵ |
| wt % Ce doped | | | | decreased | is very sensitive to reactant | |
| HPA | | | | to 85% | stream composition and | |
| | | | | | long-term stability tests for | |
| | | | | | 500 hours not done. | |
| 5 wt % Ni on acid | 800 | 300 | 84% | 88% | The synthesis of material | ⁶ |
| etched kaolinite | | | | | is very difficult, and | |
| nanosheets | | | | | activity is less than that of | |
| | | | | | current innovation. | |
| 2 wt % Nickel- | 673 | 10 | >98% | >98% | No long-term stability | ⁷ |
| Lanthanum on | | | | | tests were conducted. | |
| active carbon | | | | | | |
| (Ni—La/AC) | | | | | | |
| 84.4 wt % | 850 | 8 | ~90% | ~90% | | ⁸ |
| La₂Ce₂O₇ | | | | | | |
| (pyrochlore) | | | | | | |
| 12.8 wt % LaNiO₃ | | | | | | |
| (perovskite) | | | | | | |
| 2.7 wt % NiO | | | | | | |
| 3.76 wt % Ni, 1.76 | 800 | 850 | >98% | >98% | The material needs to be | ⁹ |
| wt % Mo on single | | | | | reduced before it becomes | |
| crystalline MgO | | | | | active, activity depends on | |
| | | | | | the crystallinity of the | |
| | | | | | support and a diluted | |
| | | | | | reactant gas stream was used. | |
| 5.29 wt % Ni | 600 | 72 | 0.175 mol_{CO2converted} | 0.12 mol_{CH4converted} | No long-term stability | ¹⁰ |
| loaded on SiO₂ | | | min⁻¹ g_{Ni}⁻¹ | min⁻¹ g_{Ni}⁻¹ | shown. | |
| and CeO₂ | | | | | | |
| 20% Ni alloyed | 850 | 500 | >98% | 95% | Present innovation in this | |
| TiO₂ | | | | stabilized | patent - Involved | |
| | | | | at 86% | concentrated reactant | |
| | | | | | stream and no further | |
| | | | | | activation required. | |
| | | | | | Different mixed metal | |
| | | | | | oxide nanowires with | |
| | | | | | active metal alloying | |
| | | | | | elements can be produced | |
| | | | | | the described method | |

TABLE 7
MW plasma catalytic tri-reforming test results.

| | Moles In (moles/min) | | | | % CO₂ | % CH₄ | | Notes on Carbon |
|---|---|---|---|---|---|---|---|---|
| Catalyst | CO₂ | CH₄ | O₂ | H₂O | Conv. | Conv. | H₂/CO | Deposition |
| No cat | 0.27 | 0.26 | 0.16 | 0.22 | 51% | 95% | 1 | Significant |
| 10% Cu—ZnO | 0.27 | 0.26 | 0.16 | 0.22 | 29% | 85% | 1 | Significant |
| 20% Cu—ZnO | 0.27 | 0.26 | 0.16 | 0.22 | 37% | 95% | 1.02 | Low |
| Ni—Ga | 0.27 | 0.26 | 0.16 | 0.22 | 39% | 96% | 0.78 | Low |

### EXAMPLE 15

The Dry reforming of methane reaction (DMR) is performed using two nanowire-based catalysts: Ni—MnO₂ and Ni—TiO₂. To prepare these catalyst samples, first MnO₂ and TiO₂ nanowire materials are made separately using thermal degradation method. In this procedure, Manganese and titanium metals are mixed with KOH (weight ratio—3:1) and a thick paste is made using a small amount of water. Then this paste is kept for heating at 550° C. for 3 h and after acid (0.5 M HCl) leaching treatment of the material, nanowires are collected at the end. These oxide nanowires are alloyed with Ni by mixing it with Ni nitrate precursor and keeping this mixture paste at 550° C. under vacuum.

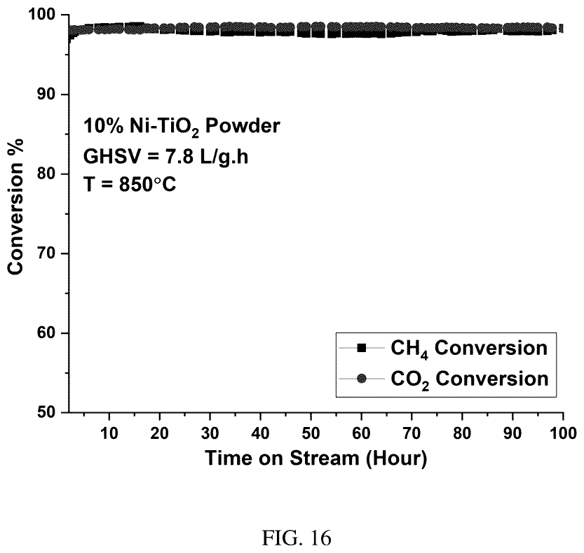

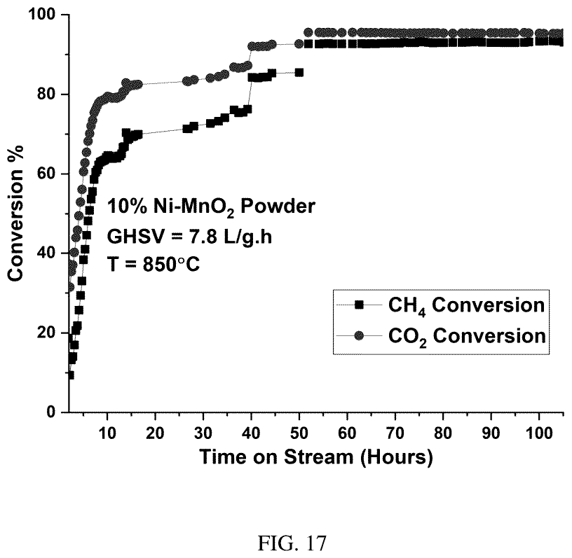

These powder catalysts are used for DMR reaction at 850° C., 7.8 L/g·h GHSV and 1 bar pressure. The DMR results showed ˜98% and 93-96% conversion (for both CH₄ and CO₂) using 10% Ni—TiO₂ and 10% Ni—MnO₂ nanowire-based catalysts respectively (FIGS. 16 and 17). However, these catalysts were not active at higher (>8 L/g·h) GHSV values because of high pressure drop through the catalyst bed. It is even noticed that the catalyst blew away from the reactor at high GHSV values and conversion directly approached zero.

In this regard, provided are structured Monolith materials coated by nanowire-based catalysts for DMR reaction. These ceramic monoliths have triangle/square shape holes or channels which actually act as catalyst carriers for the reaction. The monolith pieces are cut based on the reactor diameter and typically 6 small pieces of monolith (coated with 0.1 gm catalyst) are used here for each reaction.

The nanowire catalysts are coated inside these holes using wash coating method. In this process, monolith pieces are dipped in the catalyst slurry for 3 min and after removing the extra material, monolith pieces are kept for calcination at 500° C. for 2 hours. To make this catalyst slurry, 15 wt. % catalyst is mixed with DI water and the solution is continuously stirred for 2-3 hours. During the stirring, polyvinyl alcohol (PVA) and dispersal sol binders (2 wt. % each) are added dropwise to make the uniform slurry which easily bind at the monolith surface.

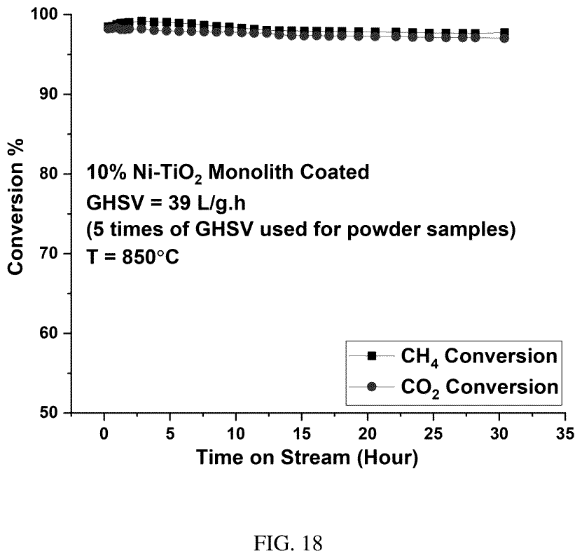

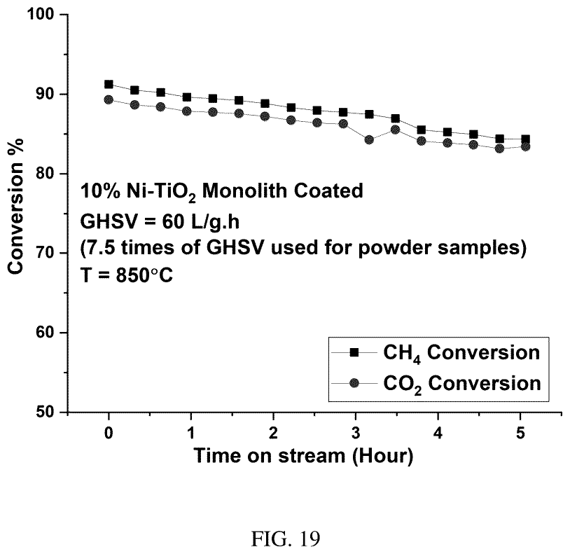

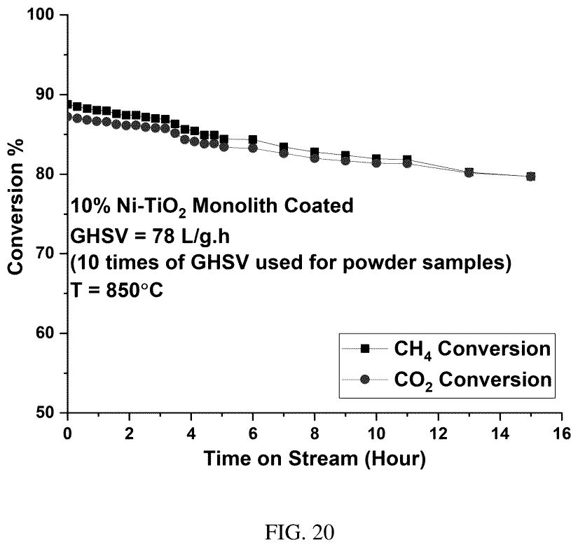

The DMR reaction was performed using these monoliths coated Ni—MnO₂ and Ni—TiO₂ catalysts at higher GHSV values (40-80 L/g·h) to study its activity with respect to powder form of the catalysts. This reaction showed outstanding performance (˜98% and 93-96% conversion for both CH₄ and CO₂) even at 5 times higher GHSV value and this activity performance was quite stable in longer time period runs (FIGS. 18-20). For GHSV>40 L/g·h, the conversion is reduced to 85-90% which is still good at high reactant flowrates. Therefore, we can surely mention that for monolith coated samples, the pressure drop is almost negligible for DMR process.

### REFERENCES

1. Akri, M.; Zhao, S.; Li, X.; Zang, K.; Lee, A. F.; Isaacs, M. A.; Xi, W.; Gangarajula, Y.; Luo, J.; Ren, Y.; Cui, Y.-T.; Li, L.; Su, Y.; Pan, X.; Wen, W.; Pan, Y.; Wilson, K.; Li, L.; Qiao, B.; Ishii, H.; Liao, Y.-F.; Wang, A.; Wang, X.; Zhang, T., Atomically dispersed nickel as coke-resistant active sites for methane dry reforming. Nature Communications 2019, 10 (1), 5181.
2. Kim, J. H.; Suh, D. J.; Park, T. J.; Kim, K. L., Effect of metal particle size on coking during CO2 reforming of CH4 over Ni-alumina aerogel catalysts. Applied Catalysis A: General 2000, 197 (2), 191-200.
3. Nie, J.; Chan, J. M.; Qin, M.; Zhou, N.; Luo, J., Liquid-like grain boundary complexion and sub-eutectic activated sintering in CuO-doped TiO2. Acta Materialia 2017, 130, 329-338.
4. Misra, S. K.; Chaklader, A. C. D., The System Copper Oxide-Alumina. Journal of the American Ceramic Society 1963, 46 (10), 509-509.
5. Akri, M.; Zhao, S.; Li, X.; Zang, K.; Lee, A. F.; Isaacs, M. A.; Xi, W.; Gangarajula, Y.; Luo, J.; Ren, Y. J. N. c., Atomically dispersed nickel as coke-resistant active sites for methane dry reforming. 2019, 10 (1), 1-10.
6. Qu, H.; Yang, H.; Han, L.; He, S.; Liu, J.; Hu, R.; Su, H.; Su, Y., Sandwich-structured nickel/kaolinite catalyst with boosted stability for dry reforming of methane with carbon dioxide. Chemical Engineering Journal 2023, 453.
7. Zhang, M.; Gao, Y.; Mao, Y.; Wang, W.; Sun, J.; Song, Z.; Sun, J.; Zhao, X. J. C. E. J., Enhanced dry reforming of methane by microwave-mediated confined catalysis over Ni-La/AC catalyst. 2023, 451, 138616.
8. Ramon, A. P.; Li, X.; Clark, A. H.; Safonova, O. V.; Marcos, F. C.; Assaf, E. M.; van Bokhoven, J. A.; Artiglia, L.; Assaf, J. M., In situ study of low-temperature dry reforming of methane over La2Ce2O7 and LaNiO3 mixed oxides. Applied Catalysis B: Environmental 2022, 315.
9. Song, Y.; Ozdemir, E.; Ramesh, S.; Adishev, A.; Subramanian, S.; Harale, A.; Albuali, M.; Fadhel, B. A.; Jamal, A.; Moon, D. J. S., Dry reforming of methane by stable Ni—Mo nanocatalysts on single-crystalline MgO. 2020, 367 (6479), 777-781.
10. Das, S.; Ashok, J.; Bian, Z.; Dewangan, N.; Wai, M. H.; Du, Y.; Borgna, A.; Hidajat, K.; Kawi, S., Silica-Ceria sandwiched Ni core-shell catalyst for low temperature dry reforming of biogas: Coke resistance and mechanistic insights. Applied Catalysis B: Environmental 2018, 230, 220-236.

It is intended that the disclosure and examples be considered as exemplary only.

While the invention has been described in terms of its preferred embodiments, those skilled in the art will recognize that the invention can be practiced with modification within the spirit and scope of the appended claims. Accordingly, the present invention should not be limited to the embodiments as described above, but should further include all modifications and equivalents thereof within the spirit and scope of the description provided herein.

1. A nanowire catalyst having the formula AₓC₁₋ₓO_{d}, wherein A is a transition metal or precious metal and wherein C is selected from the group consisting of silicon, aluminum, titanium, zinc, and manganese.

2. The nanowire catalyst of claim 1, wherein A is selected from the group consisting of nickel, iron, cobalt, tungsten, platinum, ruthenium, and iridium.

3. The nanowire catalyst of claim 1, wherein A is nickel.

4. The nanowire catalyst of claim 1, wherein the catalyst is NiₓTi₁₋ₓO_{2-d}, Ni_{y}Al_{2-y}O_{3-d}, or NiₓMn₁₋ₓO_{2-d}.

5. The nanowire catalyst of claim 1, wherein the nanowire has a length of 0.5-20 microns and a diameter of 5-200 nm.

6. The nanowire catalyst of claim 1, wherein the catalyst has the formula AₓB_{y}C_{1-x-y}O_{d} and wherein B is a precious metal and is present in an amount of 100 ppm to 5% by wt.

7. A composition comprising the nanowire catalyst of claim 1, wherein A is present in an amount of 1-20 wt %.

8. The composition of claim 7, wherein the nanowire catalyst is coated on or impregnated within a monolith.

9. The composition of claim 7, wherein the nanowire catalyst is formed into an extrudate.

10. A method for preparing a nanowire catalyst according to claim 1, comprising:
mixing a binary oxide nanowire powder having element C with a precursor of element A to form a mixture;
drying the mixture; and
calcining the mixture to provide the nanowire catalyst under inert or vacuum conditions.

11. The method of claim 10, wherein the precursor is an acetate, formate, oxalate, or nitrate precursor.

12. The method of claim 10, wherein the calcining step is performed at 250-500° C. for 0.5-3 hours.

13. A method for dry methane reforming, comprising reacting CO₂ and CH₄ in the presence of a nanowire catalyst according to claim 1 to produce CO and H₂.

14. The method of claim 13, wherein a ratio of CO₂ to CH₄ is from 2:1 to 1:2.

15. The method of claim 13, wherein the method is performed at a temperature of 700-900° C.

16. The method of claim 13, wherein the method is performed under plasma conditions using microwave, radio-frequency, or dielectric barrier discharges.

17. The method of claim 13, wherein the method is performed in a reactor comprising a packed catalyst bed and wherein the catalyst is in an extrudate form or is coated on monoliths.

18. The method of claim 13, wherein the method is performed in a reactor comprising a fluidized catalyst bed and wherein the catalyst is fluidized.

19. A method for bi-reforming of methane, comprising reacting CO₂, CH₄, and H₂O in the presence of a nanowire catalyst according to claim 1 to produce CO and H₂.

20. A method for tri-reforming of methane, comprising reacting CO₂, CH₄, H₂O, and O₂ in the presence of a nanowire catalyst according to claim 1 to produce CO and H₂.
